(19) United States
(12) Patent Application Publication
(10) Pub. No.: US 2019/0129284 A1
(43) Pub. Date: May 2, 2019

(54) DYNAMIC FILM PROJECTOR

(71) Applicant: Guangdong YUHAO Electronics Co., Ltd., Dongguan (CN)

(72) Inventor: Jun Xi, Dongguan (CN)

(21) Appl. No.: 15/814,637

(22) Filed: Nov. 16, 2017

(30) Foreign Application Priority Data
Oct. 26, 2017 (CN) 201721394460.2

(51) Int. Cl. G03B 21/02; G03B 21/14; G03B 21/20; G03B 23/10

(52) U.S. Cl. CPC G03B 21/02; G03B 21/145; G03B 23/105; G03B 21/2033; G03B 21/2013

(57) ABSTRACT

A dynamic film projector includes a driving mechanism having two rotation shafts parallelly extending upwardly, and a first projection assembly and a second projection assembly arranged side by side on the driving mechanism. At lease one of the first and the second projection assemblies includes: a light source, a lens assembly arranged in front of the light source, a dial having a shaft extending downwardly from a center thereof and several films fixed on the dial. The shafts connect the two rotation shafts of the driving mechanism. Lights from the one or more light sources are capable of passing through the one or more films and the lens assembly in sequence when the dial is driven by the driving mechanism to rotate. Along with continuous rotation of the dials, the patterns on the films are projected in sequence, so that the effect of continuous animation is realized.

### BACKGROUND OF THE INVENTION

### 1. Field of the Invention

The present invention relates to projection equipments, and specifically relates to a dynamic film projector.

### 2. Description of Related Art

Projection equipments are widely applied to every aspect in life, for example, film projection lamps are usually used in building outside wall illustration, indoor local illumination, greenery landscape illumination or stage atmosphere construction. According to different requirements, a great diversity of projection lamps can be used for simulating all kinds of scenes, such as starry sky projection lamps for simulating starry sky and projection lamps for simulating snowflake. The projection lamps generally include static projection lamps and dynamic projection lamps. The dynamic projection lamps are generally connected onto driving components, and the projection lamps can realize the actions of rotation, swinging and the like under the driving of the driving components, so that lamplight is projected to different directions, and a dynamic lamplight effect is generated. Along with the development of technology and the improvement of living standard, the awareness and demand of people also change, higher requirements are also proposed for the projection equipment of the film projection equipment, and equipment capable of projecting continuous animation is needed.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawing, in which:

FIG. 1 is an exploded view of a dynamic film projector in accordance with an embodiment of the present invention.

FIG. 2 is a perspective view of a hollow shell of a housing of the dynamic film projector in accordance with an embodiment of the present invention.

FIG. 3 is a perspective view of a rear cover, a driving mechanism, a first projection assembly and a second projection assembly of the dynamic film projector in FIG. 1.

FIG. 4 is a perspective view showing the driving mechanism, a part of the first projection assembly and the second projection assembly of the dynamic film projector in FIG. 1.

FIG. 5 is a partial perspective view of the driving mechanism, the first projection assembly and the second projection assembly of the dynamic film projector in FIG. 4.

FIG. 6 is a partial perspective view of the dynamic film projector in FIG. 3.

FIG. 7 is a perspective view of a transmission wheel of the dynamic film projector in accordance with an embodiment of the present invention.

FIG. 8 is another partial perspective view of the dynamic film projector in FIG. 3.

FIG. 9 is an enlarged view of part A in FIG. 8.

### DETAILED DESCRIPTION OF THE INVENTION

The invention will now be described in detail through several embodiments with reference to the accompanying drawings.

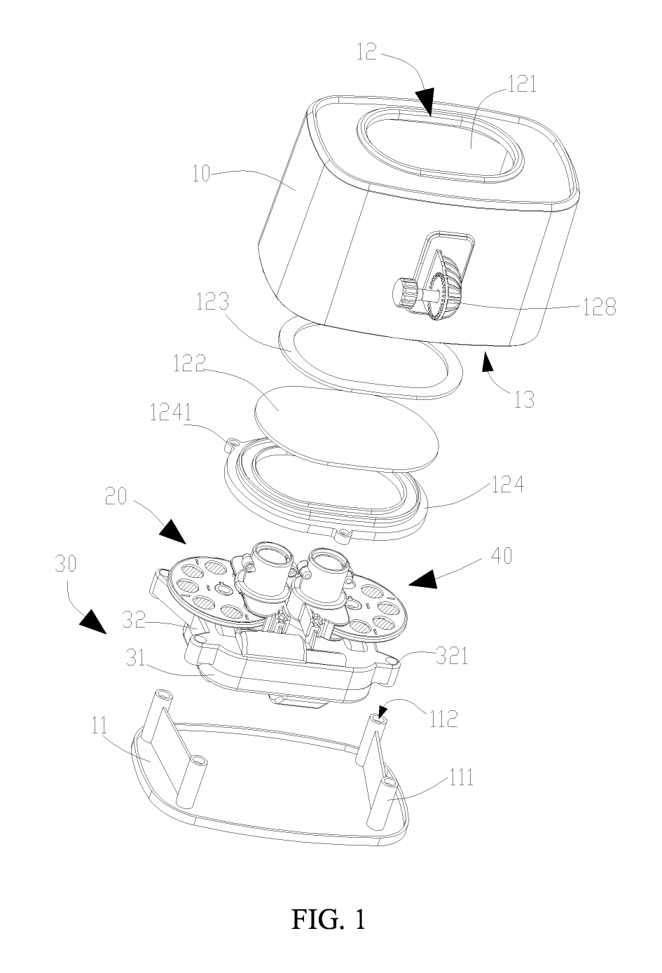

Please refer to FIG. 1, a dynamic film projector in accordance with an embodiment of the present invention mainly includes a housing, a driving mechanism 30 received in the housing, a first projection assembly 20, and a second projection assembly 40. The dynamic film projector is capable of projecting continuous animation using the driving mechanism 30, the first projection assembly 20, and the second projection assembly 40.

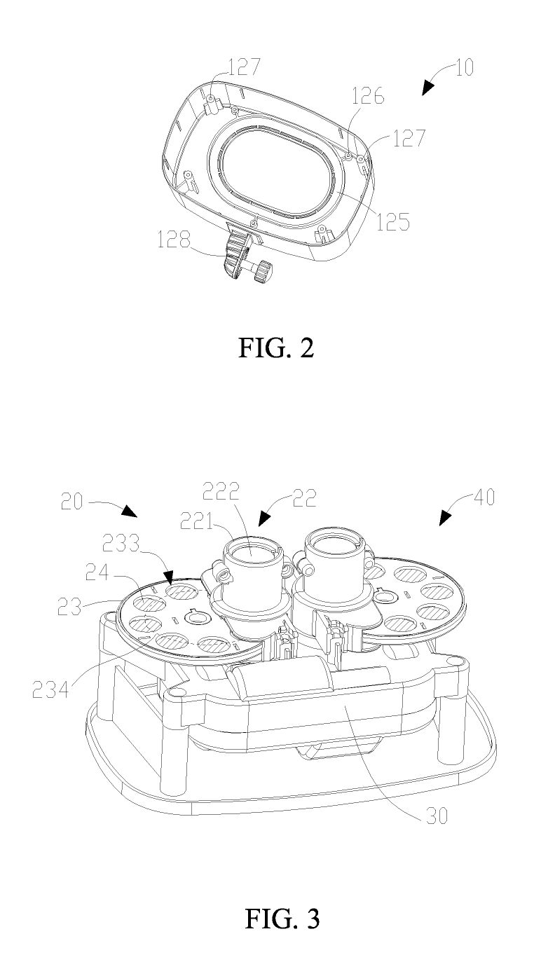

Please also refer to FIG. 2, the housing in the embodiment includes a hollow shell 10 having a transparent window 12 in its one end and defining an opening 13 at a position opposite the window 12 (that is, in the other end of the shell 10), and a rear cover 11 detachably sealing the opening 13. The shell 10 and the rear cover 11 defines a receiving space used for receiving the driving mechanism 30, the first projection assembly 20, and the second projection assembly 40. The window 12 may be integrately formed in the shell 10 or may be an independent component. In the embodiment, the shell 10 defines another opening 121 in the position of the window 12, and the window 12 is detachably sealed the opening 121. The window 12 includes a transparent plate 122, a seal ring 123 arranged between the transparent plate 122 and the edge defining the opening 121, and a fixed ring 124 fixed to an inner side of shell 10 near the edge defining the opening 121, such that the transparent plate 122 and the seal ring 123 are clapped tightly between the fixed ring 124 and the edge defining the opening 121. Preferably, a groove 125 for accommodating the seal ring 123 is defined around the edge defining the opening 121 and is used for receiving the seal ring 123. Several fixed lugs 1241 for mounting screws are arranged on a periphery of the fixed ring 124, and several fixed posts corresponding to the fixed lugs 1241 are arranged on the shell 10. A connecting part 128 for connecting an external support is further arranged on one outer surface of the shell 10. The rear cover 11 includes four mounting columns 111 extending innerwardly, and each column 111 defines a through hole 112 through out two ends of the column 111 and the rear cover 11. Four corresponding mounting columns 127 extends innerwardly from the shell 10, too.

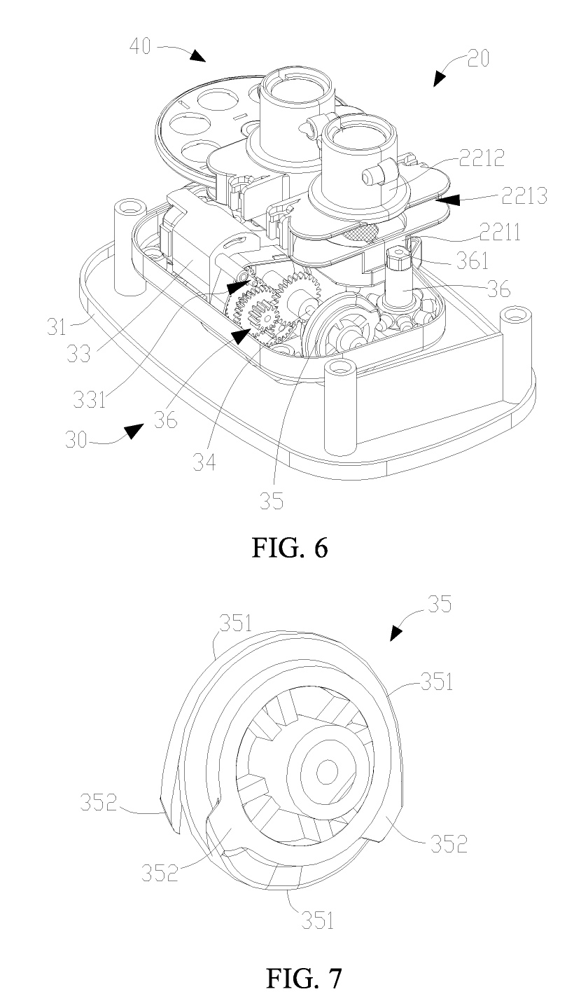

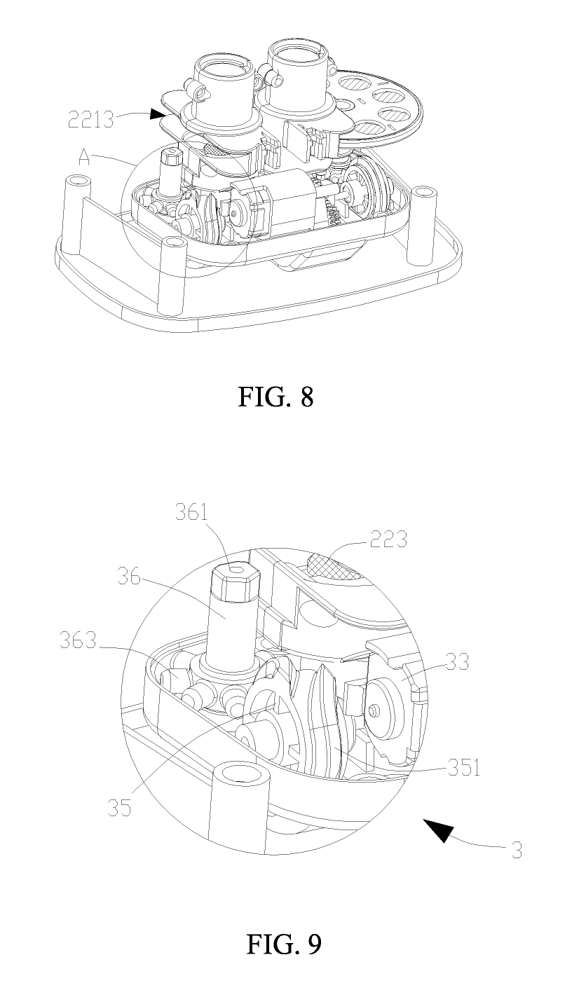

The driving mechanism 30 is used for driving the first and the second projection assemblies 20, 40. Please refer to FIGS. 1 and 5-9, in the embodiment, the driving mechanism 30 mainly includes a lower support 31, a front cover 32 covering and connected to the lower support 31 to form a receiving space, a driving device 33 fixed on the lower support 31 and having a driving shaft 331 extending from a side end of the drying device 33, a transmission shaft 34, two transmission wheels 35 fixed at two ends of the transmission shaft 34 respectively, a speed reducing assembly 36 connected between the driving shaft 331 of the driving device 33 and the transmission shaft 34, and two rotation shafts 36 mechanical coupled with the two transmission wheels 35 respectively.

The front cover 32 is detachably connected to the lower support 31 to form a receiving space. Four mounting lugs 321 corresponding to the mounting columns 111 are arranged on the periphery side of the front cover 32. Fixing components, such as blots can be inserted in the through holes 112 from an outside of the housing, then pass through the through holes defined in the mounting lugs 43, and finally screw together with the mounting columns 127 of the shell 10, as such, the shell 10, the rear cover 11, and the front cover 32 of the driving mechanism 30 are fixed together. In the other embodiments, the lower support 31 may act as the rear cover of the housing, and the rear cover 11 may be omitted.

The driving device 33 is used for outputting rotate movement. In the embodiment, the driving device 33 is a motor fixed on the lower support 31. The driving shaft 331 extends from a side end of the motor, and is substantially parallel with a plane perpendicular with a center direction of the light projecting directions of the first and the second projection assemblies 20, 40.

The speed reducing assembly 36 is used for outputting a lower rotate speed to the transmission shaft 34 when compared with a speed the driving shaft 331 of the driving device 33 outputted. In the embodiment, the speed reducing assembly 36 is a gear set, an input gear is sleeved on and fixed to the driving shaft 331 of the motor 33, and an output gear is sleeved on and fixed to the transmission shaft 34.

The transmission shaft 34 is arranged parallel with the driving shaft 331 of the motor 33. The two transmission wheels 35 are sleeved on and fixed at two ends of the transmission shaft 34 respectively. At least two convex rails 351 (there are four in the embodiment) are formed on a peripheral surface of each transmission wheel 35. The convex rails 351 extend in a spiral way. Each convex rail 351 defines a protruding part 352 at its end, the protruding parts 352 of the transmission wheel 35 are not rotational symmetric distributed in the embodiment. In other words, the convex rails 351 are not rotational symmetric distributed.

The two rotation shafts 36 are rotatably coupled to edges defining the two through holes 323 in the front cover 32 respectively. One end 361 of each rotation shaft 36 extends upwardly and is exposed outside the front cover 32 and connecting to a corresponding one of the first projection assembly 20 and the second projection assembly 40. The other end 362 of each transmission post 36 extends towards the lower support 31 and is driven by the two transmission wheels 35. Several blocks 363 protrude perpendicularly from the side wall of the end 362 of each transmission post 36, arranged around the transmission post 36, and distributed on each rotation shaft 36 rotational symmetric. That is, the two rotation shafts 36 are parallel with each other and perpendicular with the transmission shaft 34, and the several blocks 363 extend along directions substantially parally to a plane defined by the transmission shaft 34. It is understandably, the blocks 363 may extend from a ring which is sleeved on and fixed to each rotation shaft 36.

In operation, the blocks 363 of the two rotation shafts 36 mechanical coupled with the convex rails 351 of the two transmission wheels 35, therefore when the two transmission wheels 35 rotate around the transmission shaft 34, the convex rails 351 push the blocks 363 of the two rotation shafts 36 to move, the rotation shafts 36 rotate accordingly. The transmission principle of the blocks 363 and the convex rails 351 are similar to worm and gear, and when the transmission wheels rotate, the convex rails 351 can push the blocks to rotate around the axis of the rotation shafts 36, namely the rotation shafts 36 are pushed to rotate. Because the protruding parts 352 of the transmission wheel 35 are not rotational symmetric distributed, the rotation shafts 36 may have regular pauses during their rotations.

In other embodiments, similar regular pauses can be obtained when the blocks 363 are distributed on each rotation shaft 36 in a circle but not rotational symmetric, while the protruding parts 352 of each transmission wheel 35 are rotational symmetric distributed.

The first projection assembly 20 and the second projection assembly 40 are arranged side by side on an outer surface of the driving mechanism 30, and are used for projecting moving images. In the embodiment, the first projection assembly 20 and the second projection assembly 40 are the same in structures, therefore only the structure of the first projection assembly 20 is described hereinafter.

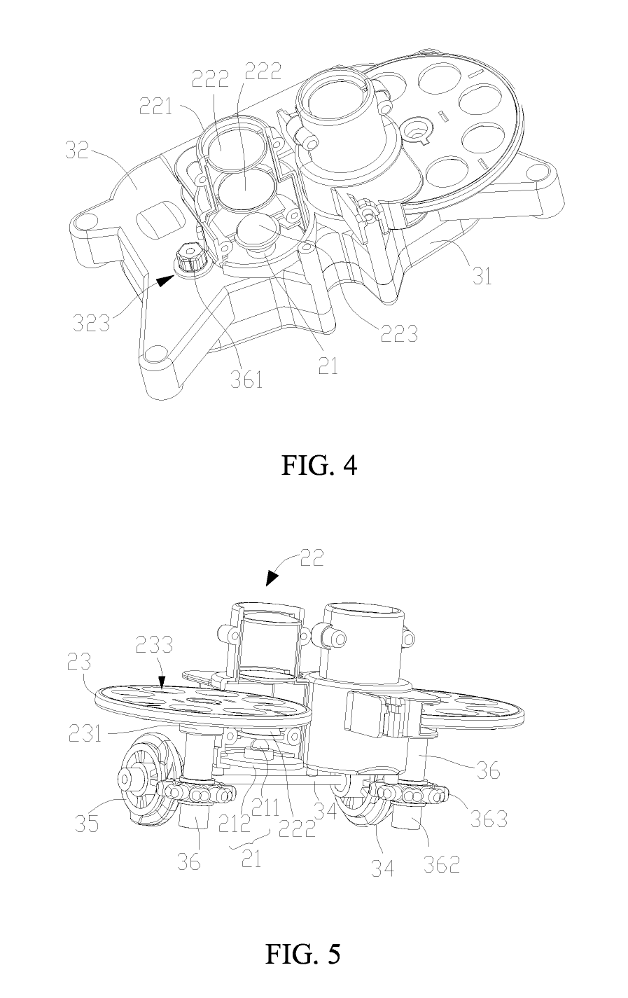

Please refer to FIGS. 1 and 3-6, the first projection assembly 20 mainly includes a light source 21, a lens assembly 22 arranged in front of the light source 21, a dial 23 having a shaft 231 extending perpendicularly from a center of the dial 23, and several films 24 fixed on the dial 23.

The light source 21 includes an LED head 211 fixed on a circuit board 212. In the embodiment, the circuit board 212 is connected to a loser end (a free end) of the lens assembly 22. In other embodiments, the circuit board 212 may be fixed on the outer surface of the driving mechanism 30. In other embodiments, there may be more than one LED head in each light source 21. In other embodiments, there may be more than one light source.

The lens assembly 22 includes a lens support 221, and two condenser lenses 222 and one magnifying lens 223 received in the lens support 221. The lens support 221 includes a first tube 2211 with its free end connected with the circuit board 212 of the light source 21, and a second tube 2212. The magnifying lens 223 is received in the first tube 2211 at a position above the light source 21 (that is, the light source 21 is more closer to the free end of the first tube 2211). The magnifying lens 223 is used for diffusing light from the LED head 211. The first tube 2211 also defines a slot 2213 in its side wall to permit the part of the dial 23 to insert in. The position of the slot 2213 is above the magnifying lens 223, that is, the magnifying lens 223 is more closer to the light source 21 than the slot 2213. Adjacent ends of the first tube 2211 and the second tube 2212 are connected and communicated with each. The two condenser lenses 222 are received in the second tube 2212.

In the embodiment, the lens support 221 is separated in two parts by a plane parallel with the center direction of the light projecting directions of the first and the second projection assemblies 20, 40. Therefore an assembly, replacement and maintenance of the lenses and the light source are easy.

In the embodiment, the front cover 32 defines two recesses 325 in its outer surface, the free end of the first tube 2211 is inserted in the corresponding recess 325 and is secured to the front cover 32.

The shaft 231 extending downwardly from the center of the dial 23 is connected with one of the two rotation shafts 36 of the driving mechanism 30, and capable of rotating along the rotation shaft 36. A part of the dial 23 inserts in the slot 2213 of the lens support 221. The dial 23 defines several through holes 233 arranged in a circle 234 (shown in a broken line in FIG. 3). In the embodiment, the dial 23 is a bilayer structure. The films 24 are clamped within the bilayer structure and seal the through holes 233.

Each film 24 may include a film base made from polyethylene terephthalate (PET), and several printing layers prined on a front surface of the film base in sequence. Each printing layer is formed by screen printing utilizing a color anti-uv(ultraviolet light) screening ink and all these layers form a preset pattern. Furthermore, a thinkness of the film base is 0.8-1.5 mm, a total thinkness of the several printing layers is 0.05-0.1 mm. Therefore, the film 24 can resist a temperature higher than 80 degrees Celsius without deformation and color fading. Patterns of all the films 24 may be different, or may be the same with each other but are configured rotationally symmetrical around the shaft 231. In other embodiments, there may be only one annular film covering all the through holes 233 in the dial 23.

A center of the light source 21, a center of the lens assembly 22 and a point in the circle 234 lie in a straight line, such that lights from the light source 21 are capable of passing through one of the films 24 at a time and then the lenses of the lens assembly 22 and the window 12 in sequence when the dial 23 is driven by the driving mechanism 30 to rotate. Therefore moving images are projected out of the dynamic film projector. Because the regular pauses exist during the rotation of the rotation shafts 36, each imaged corresponding to a preset pattern on the films 24 may be paused for a preset time periode. In detail, each film can stay for a certain period of time above the light source at the moment the dial 23 pauses, and thus the preset pattern of the film can be projected.

In assembly, firstly, the first and second projection assemblies 20, 40 are connected onto the fixed support of the driving mechanism by inserting the lens support in the recesses of the fixed support and connecting the dials to the rotation shafts 36. Then connecting the hosing and the driving mechanism together.

When a power supply is powered, the driving device of the driving mechanism, namely the motor, rotates, the transmission shaft is driven to rotate, and then the transmission shaft drives the dial of the first projection assembly and the dial of the second projection assembly to rotate. When the dials rotate, the films rotate above the light source, the film has intermittent short stays, and the patterns on the film can be projected at the moment. Along with continuous rotation of the dials, the patterns on the other films also are projected in sequence, so that the effect of continuous animation is realized. Simultaneously, the films on the dials can be changed and adjusted according to specific requirements.

In other embodiments, the first and the second projection assemblies may have different structures from each other. The second projection assembly may have no rotatably dial, and can only project still image, while the first projection assembly has the dial connected with the driving mechanism. Therefore, the second projection assembly can project still images and the first projection assembly can project maving images. Accordingly, the driving mechanism may only having one rotation shaft and one transmission wheel.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A dynamic film projector, comprising:
a housing comprising a transparent window;
a driving mechanism received in the housing and having one or two rotation shafts extending towards the transparent window; and
a first projection assembly and a second projection assembly arranged side by side on the driving mechanism;
wherein at lease one of the first and the second projection assemblies comprises:
one or more light sources;
a lens assembly comprising one or more lenses and configured in front of the one or more light sources;
a dial having a shaft extending perpendicularly from a center thereof and defining a plurality of through holes arranged in a circle, the shaft being connected with one of the one or two rotation shafts of the driving mechanism; and
one or more films configured on the dial and sealing the plurality of through holes;
wherein a part of the dial is configured between the one or more light sources and the one or more lenses, and lights from the one or more light sources are capable of passing through the one or more films, the lens assembly and the transparent window in sequence when the dial is driven by the driving mechanism to rotate.

2. The dynamic film projector according to claim 1, wherein the lens assembly further comprises a lens support comprising:
a first tube configured for covering or connected to the one or more light sources; and
a second tube configured for receiving at least a part of the one or more lenses;
wherein the first tube defining a slot in its side wall to permit the part of the dial to insert in, and adjacent ends of the first tube and the second tube are connected and communicated with each other.

3. The dynamic film projector according to claim 2, wherein there is one light source comprising one or more LED heads fixed on a circuit board, the circuit board is secured to a free end of the first tube or is fixed on the driving mechanism.

4. The dynamic film projector according to claim 3, wherein there are two condenser lenses received in the second tube, and one magnifying lens received in the first tube at a position more closer to the light source than the slot; the magnifying lens is configured for diffusing light from the one or more LED heads.

5. The dynamic film projector according to claim 4, wherein the first projection assembly and the second projection assembly are the same in structures.

6. The dynamic film projector according to claim 1, wherein the driving mechanism comprises two rotation shafts, and further comprises:
a lower support fixed to the housing or acting as a rear cover of the housing;
a front cover covering the lower support to form a receiving space and defining two through holes;
a driving device fixed on the lower support and having a driving shaft extending from a side end thereof;
a transmission shaft;
two transmission wheels fixed at two ends of the transmission shaft respectively and mechanical coupled with the two rotation shafts;
a speed reducing assembly connected between the driving shaft of the driving device and the transmission shaft and configured for outputting a lower rotate speed to the transmission shaft when compared with a speed the driving shaft of the driving device outputted;
wherein the two rotation shafts rotatably coupled to edges defining the two through holes of the front cover respectively, one end of each rotation shaft is exposed outside the front cover and connecting to a corresponding shaft of the two dials, and the other end of each transmission post is driven by the two transmission wheels.

7. The dynamic film projector according to claim 6, wherein a plurality of blocks protrude perpendicularly from a side wall or side walls of or near the other end of each transmission post; at least two convex rails are formed on each transmission wheel, when the two transmission wheels rotate around the transmission shaft, the convex rails push the plurality of blocks of the two rotation shafts to move, therefore driving the two rotation shafts to rotate.

8. The dynamic film projector according to claim 7, wherein the driving device comprises a motor.

9. The dynamic film projector according to claim 7, wherein the plurality of blocks are distributed on each rotation shaft rotational symmetric, each convex rail defines a protruding part at its end, the protruding parts of the transmission wheel are not rotational symmetric distributed.

10. The dynamic film projector according to claim 7, wherein the plurality of blocks are distributed on each rotation shaft in a circle but not rotational symmetric, each convex rail defines a protruding part at its end, the protruding parts of the transmission wheel are rotational symmetric distributed.

11. The dynamic film projector according to claim 7, wherein the front cover defines two recesses in its outer surface, ends of the lens assemblies of the first projection assembly and the second projection assembly are inserted in the two recesses respectively and are secured to the front cover.

12. The dynamic film projector according to claim 11, wherein the lens assembly further comprises a lens support comprising:
a first tube with a free end inserted in a corresponding one of the two recesses and covering or connected with the one or more light sources; and
a second tube configured for receiving at least a part of the one or more lenses;
wherein the first tube defining a slot in its side wall to permit the part of the dial to insert in, and adjacent ends of the first tube and the second tube are connected and communicated with each other.

13. The dynamic film projector according to claim 12, wherein there is one light source comprising an LED head fixed on a circuit board which is fixed in a corresponding one of the two recesses or is fixed to the first tube of the lens support.

14. The dynamic film projector according to claim 13, wherein there are two condenser lenses received in the second tube, and one magnifying lens received in the first tube at a position more closer to the light source than the slot; the magnifying lens is configured for diffusing light from the LED head.

15. The dynamic film projector according to claim 14, wherein the housing comprises a hollow shell having the transparent window and defining an opening and a rear cover detachably sealing the opening, the driving mechanism is fixed on the rear cover.

16. A dynamic film projector, comprising
a housing comprising a transparent window;
a driving mechanism received in the housing and having one or two rotation shafts extending towards the transparent window; and
a first projection assembly and a second projection assembly arranged side by side on the driving mechanism;
wherein at lease one of the first and the second projection assemblies comprises:
one or more light sources;
a lens assembly comprising one or more lenses and configured in front of the one or more light sources;
a dial having a shaft extending perpendicularly from a center thereof and defining a plurality of through holes arranged in a circle, the shaft being connected with one of the one or two rotation shafts of the driving mechanism; and
one or more films configured on the dial and sealing the plurality of through holes;
wherein a part of the dial is configured between the one or more light sources and the one or more lenses, and a center of the one or more light sources, a center of the lens assembly and a point of the circle lie in a straight line, such that lights from the one or more light sources are capable of passing through the one or more films, the lens assembly and the transparent window in sequence when the dial is driven by the driving mechanism to rotate.

17. The dynamic film projector according to claim 16, wherein the lens assembly further comprises a lens support comprising:
a first tube configured for covering or connecting the one or more light sources; and
a second tube configured for receiving at least a part of the one or more lenses;
wherein the first tube defining a slot in its side wall to permit the part of the dial to insert in, and adjacent ends of the first tube and the second tube are connected and communicated with each other.

18. The dynamic film projector according to claim 17, wherein the driving mechanism comprises two rotation shafts, and further comprises:
a lower support fixed to the housing or acting as a rear cover of the housing;
a front cover covering the lower support to form a receiving space and defining two through holes;
a driving device fixed on the lower support and having a driving shaft extending from a side end thereof;
a transmission shaft;
two transmission wheels fixed at two ends of the transmission shaft respectively and mechanical coupled with the two rotation shafts;
a speed reducing assembly connected between the driving shaft of the driving device and the transmission shaft and configured for outputting a lower rotate speed to the transmission shaft when compared with a speed the driving shaft of the driving device outputted;
wherein the two rotation shafts rotatably coupled to edges defining the two through holes of the front cover respectively, one end of each rotation shaft is exposed outside the front cover and connecting to a corresponding shaft of the two dials, and the other end of each transmission post is driven by the two transmission wheels.

19. The dynamic film projector according to claim 18, wherein a plurality of blocks protrude perpendicularly from a side wall or side walls of or near the other end of each transmission post; at least two convex rails are formed on each transmission wheel, when the two transmission wheels rotate around the transmission shaft, the convex rails push the plurality of blocks of the two rotation shafts to move, therefore driving the two rotation shafts rotate.

20. The dynamic film projector according to claim 19, wherein the front cover defines two recesses in its outer surface, the light sources of the first projection assembly and the second projection assembly are fixed in bottoms of the two recesses respectively or are fixed to the first tube of the lens support; the free end of the first tube of the lens assembly is inserted in a corresponding one of the two recesses and is secured to the front cover.
